(19) United States
(12) Patent Application Publication
(10) Pub. No.: US 2002/0093986 A1
(43) Pub. Date: Jul. 18, 2002

(54) Forward data de-skew method and system

(76) Inventors: Norm Hendrickson, Colorado Springs, CO (US); Andrew Schmitt, Salem, NH (US)

Correspondence Address: CHRISTIE, PARKER & HALE, LLP, 350 WEST COLORADO BOULEVARD, SUITE 500, PASADENA, CA, 91105, US

(21) Appl. No.: 10/036,563

(22) Filed: Dec. 31, 2001

Related U.S. Application Data
(60) Provisional application No. 60/259,968, filed on Dec. 30, 2000.
(60) Provisional application No. 60/260,079, filed on Jan. 4, 2001.
(60) Provisional application No. 60/261,868, filed on Jan. 10, 2001.
(60) Provisional application No. 60/260,628, filed on Jan. 8, 2001.

(51) Int. Cl. H04J 3/06

(52) U.S. Cl. 370/503

(57) ABSTRACT

Systems and methods for deskewing parallel data lines using at least one extra channel in parallel to the parallel data lines to carry data for comparing to data on the parallel data lines.

### CROSS-REFERENCE TO RELATED APPLICATIONS

This application claims the benefit of U.S. provisional application No. 60/259,968 filed Dec. 30, 2000, No. 60/260,079 filed Jan. 4, 2001, No. 60/260,628 filed Jan. 8, 2001, and No. 60/261,868, filed Jan. 10, 2001 which are hereby incorporated by reference as if set forth in full herein.

### BACKGROUND OF THE INVENTION

The present invention relates generally to parallel data alignment, and more particularly to synchronization of high speed parallel data transmissions.

The capabilities of information processing systems are constantly expanding. Such systems are increasingly called upon to process large amounts of information very quickly. The ability of information processing systems to act on information is dependent on the rate at which the system may receive information and the speed at which the system can process that information. In order to receive information more quickly, the systems are often provided information on parallel data lines. The information provided on the parallel data lines is generally associated together to form blocks of information. The use of parallel data lines allows a system to receive multiple pieces of information at any given moment.

A problem with parallel data lines is that transmission times across the data lines may vary, or skew, due to line lengths, process variations, aging, and environmental conditions. If the data transmission times are sufficiently different, then the information processing system may not group pieces of information received on the data lines in the proper format. The increased rate at which information processing systems process information also results in a decreased tolerance of variation in data transmission time. Thus, if information processing speeds increased by a factor of 10, such has occurred in the last several years, the allowable variation in transmission time decreases significantly.

Furthermore, information processing systems have increasingly been linked in ever greater computer networks, such as the Internet. The demand for information across these networks is tremendous, and has largely been met by ever increasing the rate in which information has passed between network nodes. For example, fiber optic transmission systems have increased data throughput such that data transmission rates have increased from 1.25 gigabits per second (Gb/s) to 2.5 Gb/s, 10 Gb/s, and are shortly expected to reach rates of 40 Gb/s. While specialized components may be able to receive data at such increased rates, the data rate is often slowed down for processing of the data by less specialized components. A common method of reducing a data rate is to deserialize, or put in parallel, received serial data. For example, serial data transmitted at 40 gigabits per second may be deserialized into a 16 bit bus operating at 2.5 gigahertz. At 2.5 Gb/s, however, skew tolerance for process variations and other factors is often minimal.

### SUMMARY OF THE INVENTION

The present invention provides parallel data de-skew systems and methods. In aspects of the present invention a sample data channel is provided in parallel to parallel data channels to allow for deskewing of the parallel data channels. The sample data channel carries sample data, which in some aspects is data sampled from data for transmission over the parallel data channels. In some aspects the sample data channel carries a forward data sample in the same direction of transmission as data transmitted over the parallel data channels. In aspects of the present invention the sample data is compared with data transmitted over the parallel data channels to allow for adjustment of skew in signal paths of data transmitted over the parallel data channels.

In one aspect of the invention a de-skew system comprises a plurality of data channels over which data is transmitted. A plurality of selectors are coupled to the plurality of data channels. A controller is coupled to the plurality of selectors and configured to cause the selectors to provide data from a desired data channel for transmission over a forward data sample channel. In a further aspect data transmitted over the forward data sample includes a header. In yet a further aspect the de-skew system comprises a processor receiving data from the plurality of data channels and the forward data sample channel. A deskew module is configured to collect portions of the received data and to adjust collection of each of the received data based on the received forward data sample and the collected portions of the received data.

In one aspect of the invention a processor is configured to receive input data and generate parallel data. A buffer unit receives the generated parallel data and a clock signal and generate a plurality of data signals based on the received generated data and clock signal. A control unit is configured to collect portions of the plurality of data signals and to generate a forward data sample based on the collected portions of the plurality of data signals.

One aspect of the invention is a de-skew method. The method includes receiving data from a plurality of data channels, selecting a portion of data from each of the received data, and generating a forward data sample comprising the selected portions of the data. A further aspect includes receiving the forward data sample, identifying the portion of the data correspond to received data from the plurality of data channels, determining a delay based on timing between the portion of data and the corresponding received data, and passing the received data along the plurality of data channels after the determined delay.

One aspect of the invention is a de-skew method comprising centering a forward data sample, comparing the forward data sample to data on one of a plurality of data channels, and determining a time variation between the data and the forward data sample.

One aspect of the invention comprises determining a channel number for a forward data sample, retrieving data from a data channel identified by the channel number, the data channel being a first data channel, comparing the data from the first data channel with a slice of delayed data from the forward data sample, and adjusting timing of the forward data sample when the data from the first data channel corresponds to the slice of the delayed data.

One aspect of the invention comprises selecting data from specific channel of a plurality of channels, centering skew adjustment for the specific channel, adjusting a forward data sample until data in the forward data sample matches the selected data, selecting another channel of the plurality of channels, adjusting skew on the selected channel until data in the selected channel matches the forward data sample, and rotating through all the plurality of channels to select and adjust skew of all the plurality of channels to match the forward data sample.

One aspect of the invention comprises a method of deskewing parallel data channels between a transmitting unit and a receiving unit using a forward sample channel, the transmitting unit providing data signals to the receiving unit over the parallel data channels and also providing sample signals to the receiving unit over the forward sample channel, the method comprising selecting a data channel for deskewing, transmitting data over the data channel, transmitting the data over the forward sample channel, comparing received data transmitted over the data channel with received data transmitted over the forward sample channel, and deskewing the data channel based on the comparison.

One aspect of the invention comprises providing parallel data over a plurality of parallel data lines, successively providing sample data over a sample channel, the sample data corresponding to data of the parallel data, and using the sample data to align the parallel data.

One aspect of the invention is a system including deskew functions comprising an upstream unit providing parallel data to a downstream unit over parallel data channels, a downstream unit receiving the parallel data from the upstream unit over the parallel data channels, and a sample channel coupling the upstream unit and the downstream unit, the sample channel carrying samples of the parallel data.

These and other aspects of the present invention will be more readily understood upon review of the accompanying drawings and following detailed description.

### BRIEF DESCRIPTION OF THE DRAWINGS

FIG. 1 is a block diagram of a de-skew system in accordance with aspects of the present invention;

FIG. 2 is a further block diagram of a unit providing a serial/parallel interface function;

FIG. 3A is a block diagram of an upstream serializer/deserializer (SERDES) unit providing a forward data sample;

FIG. 3B is a block diagram of an upstream processing unit providing a forward data sample;

FIG. 4 is a flow diagram of a process of providing data on a sample channel;

FIG. 5 illustrates a semi-schematic diagram of one embodiment of a unit providing data on a sample channel;

FIG. 6 illustrates a block diagram of one embodiment of a unit providing data on a sample channel;

FIG. 7 is a block diagram of a downstream processing unit providing a deskew function using data from a sample channel;

FIG. 8 illustrates a flow diagram of a process implemented by a downstream unit to de-skew data channels;

FIG. 9 is a flow diagram of a subprocess for setting a sampling point for a first data channel;

FIG. 10 is a flow diagram of a subprocess for adjusting a forward data sample delay;

FIG. 11 is a flow diagram of a subprocess for adjusting the skew of data channels;

FIG. 12 is a semi-schematic diagram of one embodiment of a processing unit providing a deskew function using data from a sample channel;

FIG. 13 is a block diagram of one embodiment of a processing unit providing a deskew function using data from a sample channel;

FIG. 14 is a semi-schematic diagram of portions of a unit performing a de-skew or pre-skew operations; and

FIG. 15 illustrates an exemplary header transmitted with a data sample.

### DETAILED DESCRIPTION

In one aspect of the present invention a sample channel is provided in parallel with a plurality of data channels. The sample channel carries copies of data carried by the data channels, and the sample channel is used to time, or synchronize or de-skew, the data channels.

In one embodiment the sample channel is provided data from the data channels at a transmitting side. A receiving side compares data transmitted on the sample channel with corresponding data transmitted on a data channel to bit, byte and/or word align successive data channels.

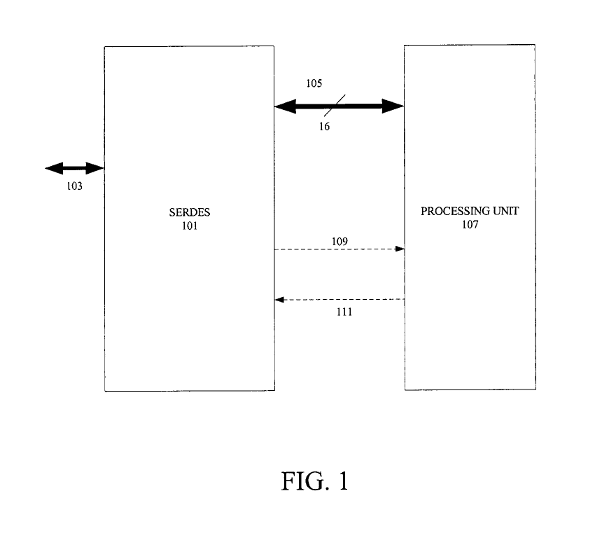

FIG. 1 illustrates a system in accordance with the present invention. As illustrated, the system includes a serializer/deserializer (SERDES) 101. In alternative embodiments the SERDES is replaced by a processor or other unit, with the processor or other unit containing functions such as, for example, those hereinafter described. The SERDES receives communication data over a transmission link 103. The transmission link is often a fibre optic cable coupled to a photodiode, transimpedance amplifier, and other receiving circuitry (not shown). The SERDES deserializes the communication data and places the deserialized data ona bus 105, including an output bus. In the embodiment illustrated the output bus is a 16-bit bus. The SERDES is therefore a 1:16 deserializer, and the output bus includes 16 data channels.

The output bus is coupled to a processing unit 107. The processing unit processes the deserialized data. As the data transmitted on the output bus includes data received over a plurality of clock cycles from the transmission links, a clock cycle of the output bus is, in the embodiment described, 16 times longer than that of the transmission link. Thus, the processing unit may operate at clock speeds that are a fraction of the clock speed of the SERDES.

The processing unit in various embodiments performs a variety of functions. In one embodiment, the processing unit receives data on the output bus and arranges the data in frames. For example, when the processing unit is utilized as part of a SONET communication system, the processing unit descrambles the data as appropriate and frames the data using, for example, the A1A1A1A2A2A2 framing pattern. In other embodiments the processing unit may perform forward error correction processing or other processing.

The SERDES also receives data from the processing unit over the bus, as illustrated including an input bus. The SERDES serializes the data and provides the data over the transmission link.

Also coupling the SERDES and the processing unit is a sample channel 109. In one embodiment, the SERDES places information from different channels of the output bus onto the sample channel at predefined intervals. In another embodiment the SERDES places information from different channels of the output bus onto the sample channel in response to a command or request from the processing unit. The information provided on the sample channel allows the processing unit to adjust for transmission time variations, or skew, in the data channels.

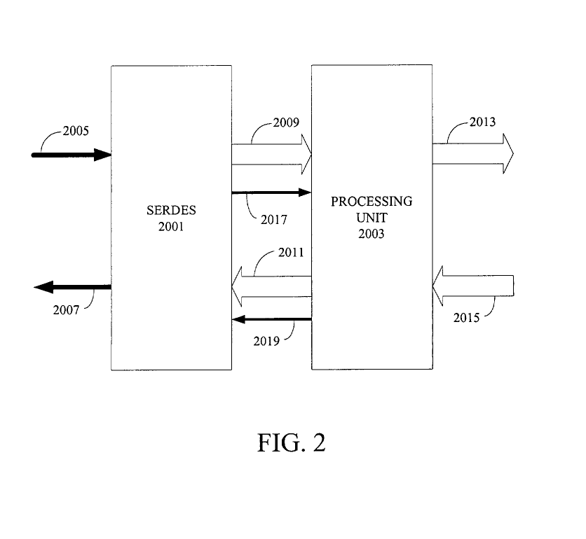

FIG. 2 illustrates a further block diagram of a unit providing a serial/parallel interface function. The unit includes a SERDES 2001 and a processing unit 2003. The SERDES is bi-directional as it performs both a serialization and deserialization function. Accordingly, the SERDES receives data from a first serial transmission line 2005 and also provides data on a second serial transmission line 2007. The SERDES receives the serial data on the first serial data line and deserializes the data to provide parallel data 2009 to the processing unit. Conversely, the SERDES receives parallel data 2011 from the processing unit and serializes the parallel data for transmission on the second serial data line. The processing unit provides parallel data 2013 to other units (not shown), as well as receives parallel data 2015 from other units.

In addition the SERDES also provides a serial sample signal 2017 to the processing unit, as well as receives a serial sample signal 2019 from the processing unit. Accordingly, the SERDES and processing unit have a parallel interface, with the parallel interface including data signals and a sample signal associated with the data signals.

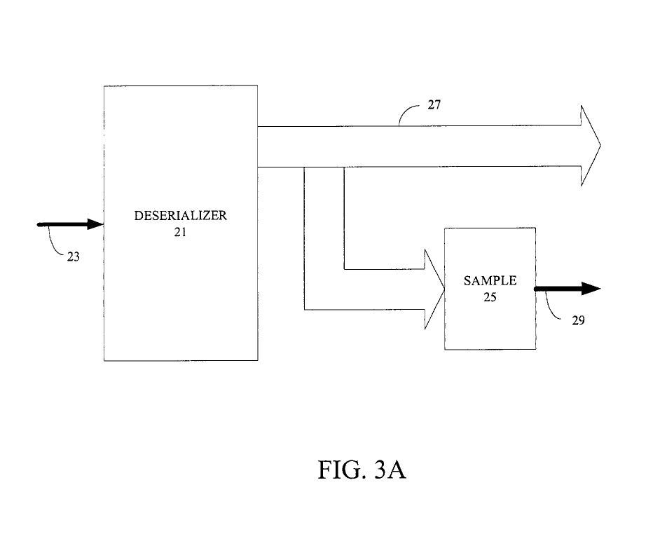

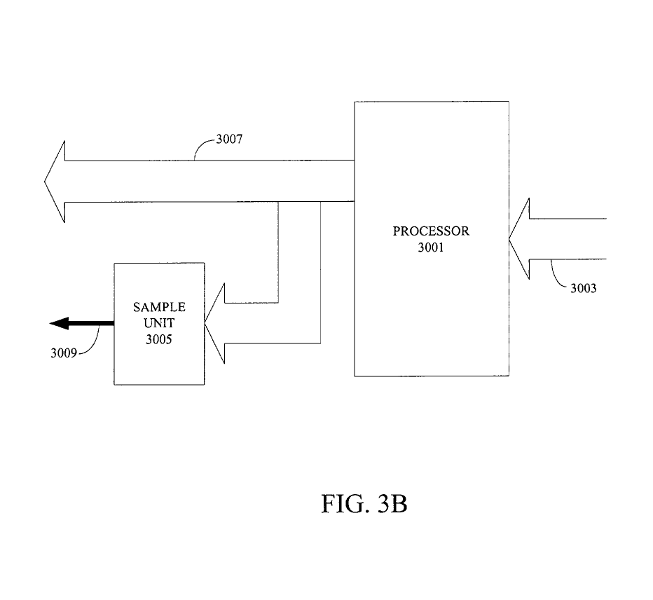

FIG. 3A illustrates a block diagram of a transmitting (up stream) side of a system using a forward data sample. As illustrated, the up stream device is a SERDES device, with the deserializer function illustrated. Accordingly, a deserializer 21 receives a serial data stream 23. The deserializer deserializes the data stream and forms a plurality of data streams 27. The data streams are provided over a parallel transmission system to another component (not shown).

The plurality of data streams are also provided to a sample unit 25. The sample unit provides a data stream 29, in part by selecting one of the data streams to the other component.

In various embodiments the sample unit selects data streams for transmission to the other component using various criteria. In one embodiment the sample unit periodically selects a particular data stream, with thedata streams selected, for example, in round robin fashion. In some embodiments the selected data stream is based on a signal generated by the other component. For example, in one embodiment the other component provides a signal commanding selection of a particular data stream, and in another embodiment the other component provides a signal that serves as a start signal for selection of a particular data stream followed by periodic selection of other data streams.

FIG. 3B is a block diagram of a portion of a processing unit providing data to a SERDES. The processing unit includes a processor 3001 which processes received parallel data 3003 and outputs parallel data 3007. The parallel data is also provided to a sample unit 3005. The sample unit selectively places data from the parallel data lines onto a sample channel 3009. In various embodiments, the processing unit may be such as a framer or FEC processor.

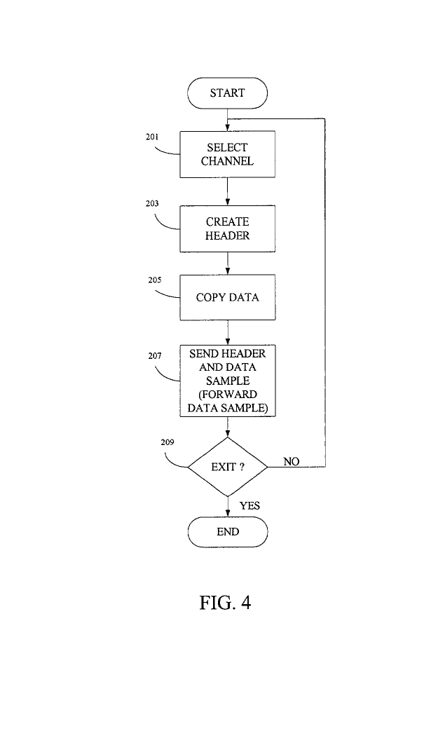

FIG. 4 illustrates a flow diagram of a process performed by, for example, the SERDES. For example, with respect to FIGS. 3A and 3B the process is performed by the sampling unit. Those of ordinary skill in the art will recognize that generally the process of FIG. 4, and various other processes, is generally implemented in hardware, with the hardware functions described, for example, through the use of a design language such as HDL, VHDL, or the like. The design language is thereafter synthesized and otherwise processed to provide the hardware component layout.

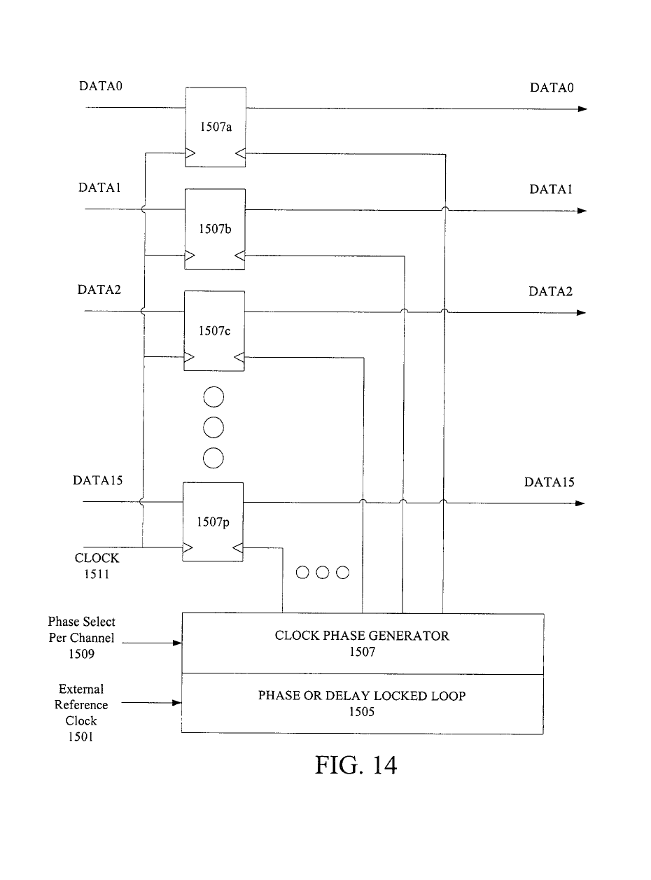

In Block 201 of the process of FIG. 4 a channel is selected. The channel is one of, for example, 16 data channels. In Block 203 the process creates a header. The header comprises, in one embodiment, a channel number and status word. The channel number is indicative of the selected channel. The status word allows for transmission of further additional information, or other out of data channel information, from the SERDES to the processing unit. The header is described in greater detail in reference to FIG. 14.

In Block 205 the process copies data from the selected channel. The copied data is a predetermined number of bytes from the selected channel. In Block 207 the process transmits the header and copied data from the SERDES to the processing unit. The header and copied data together comprise a forward data sample. In Block 209 the process determines if an exit has been commanded. If no exit has been commanded, the process returns to Block 201 and selects a further channel for transmitting a further data sample. In one embodiment the channels are selected on a round-robin basis, although in other embodiments other selection criteria are used.

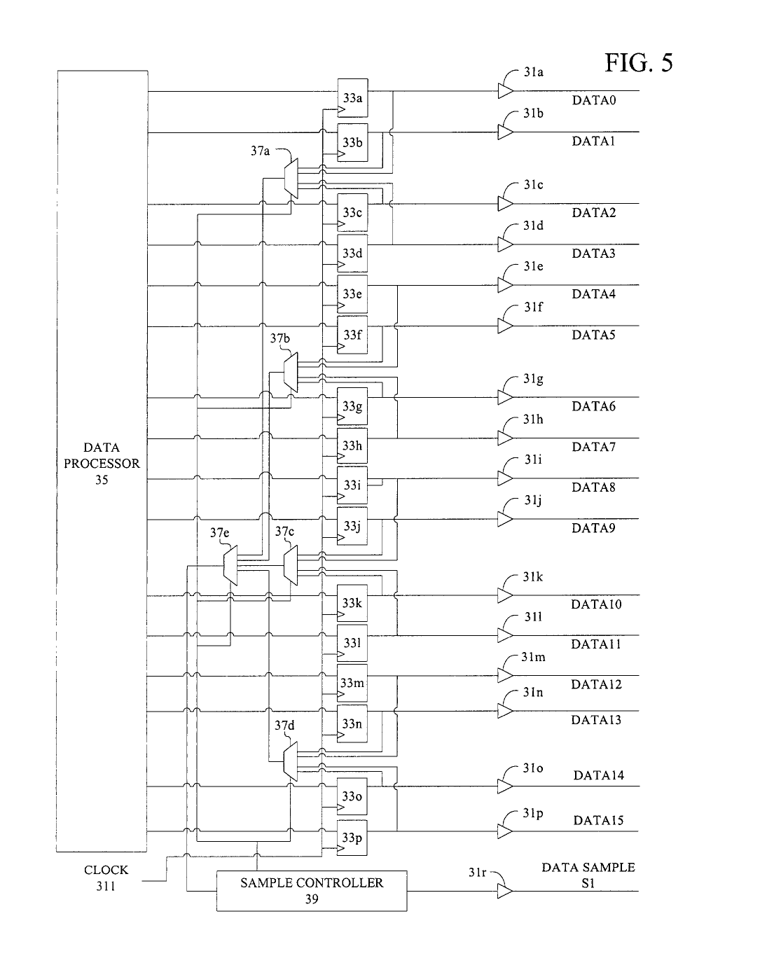

FIG. 5 illustrates a semi-schematic diagram of an upstream unit, such as a SERDES. The upstream unit of FIG. 5 provides 16 data channels DATA0-DATA15. The upstream unit also provides a forward data sample channel S1. The channels are driven by buffers 31a-p. In various embodiments, depending on the physical characteristics of the layout, such as whether the upstream unit and downstream unit (not shown in FIG. 5) are part of a common chip, separate modules within a module, or are separate chips, the buffers are replaced by a variety of different driving units.

The data received by each of the buffers is clocked by clock signal 311. Accordingly, as illustrated, each of the buffers receives data from a corresponding latch from latches 33a-p. Each latch receives data from a data processor 35. For a SERDES, for example, the data processor performs a deserializing function.

Each of the outputs of the latches are also provided to multiplexers. As illustrated, five 4×1 multiplexers 37a-37e are utilized to select a data sample. Accordingly, data samples DATA0-DATA3 are provided to a first multiplexer 37a, data samples DATA4-DATA7 are provided to a second multiplexer 37b, data samples DATA8-DATA11 are provided to a third multiplexer 37c, and data samples DATA12-DATA15 are provided to a fourth multiplexer 37d. The output of each of the first, second, third, and fourth multiplexers are in turn provided to a fifth multiplexer 37e, whose output is provided to a sample controller 39.

The sample controller controls the selectors of the multiplexers 37a-e so as to be able to select data from a particular data channel. The sample controller also provides data to the output buffer for the data sample. Thus, the sample controller selects a data channel, sets the appropriate selectors from the multiplexers, receives the output of the fifth multiplexer, and appends the data from the data channel to the header to form a forward data sample S1. The sample controller provides the forward data sample to the buffer 31r for transmission to a processing unit (not shown).

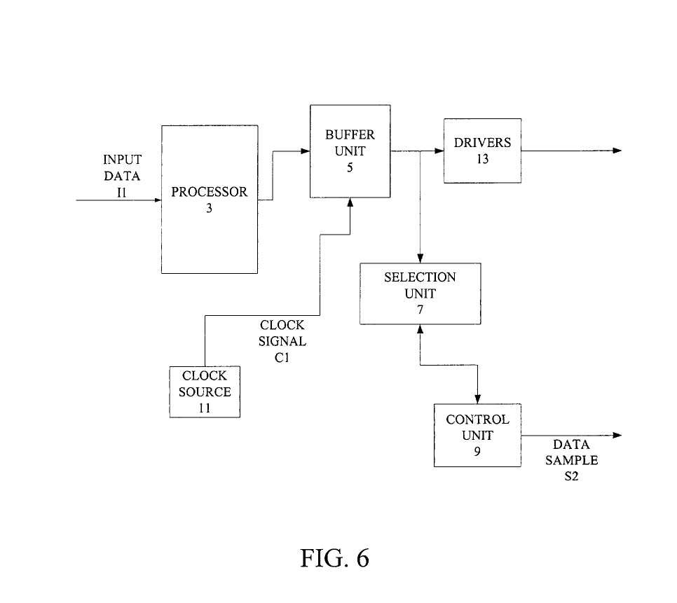

FIG. 6 illustrates a block diagram of a further embodiment of a system which is configured to perform the process of FIG. 4. In FIG. 6, a processor 3 receives input data I1. The input data, in one embodiment, is information provided via an optical link. The processor de-serializes the data and supplies the data, in parallel form, to a buffer unit 5. In another embodiment the processor receives parallel data, processes the parallel data, and provides parallel data to the buffer unit. A clock source 11 also supplies a clock signal C1 to the buffer unit 5. Based on the clock signal, the buffer unit forwards data to drivers 13. The drivers transmit the data to, in one embodiment, another processing unit (not shown).

The buffer unit also forwards data to a selection unit 7. A control unit 9 is coupled to the selection unit and commands the selection unit to generate or select specific samples or portions of data received from the buffer unit. In one embodiment, the data selection is performed in a round-robin fashion. The control unit aggregates the samples of data to form a data sample signal S2. The control unit transmits the data sample signal to, in one embodiment, another processing unit (not shown).

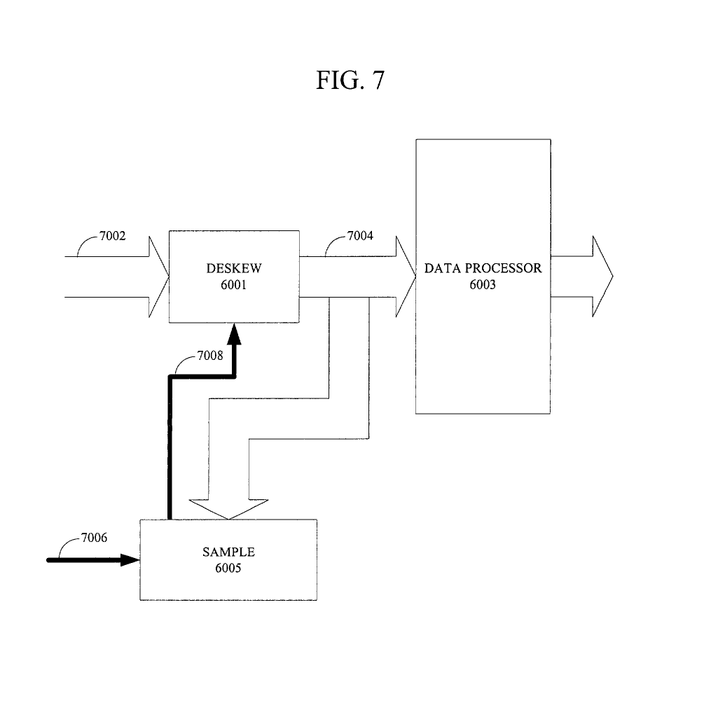

The processing unit uses the forward data sample to de-skew the data channels. FIG. 7 illustrates a block diagram of one embodiment of the processing unit. The processing unit is provided data on parallel data lines 7002. The parallel data lines are provided to de-skew circuitry 6001. The de-skew circuitry delays each channel that make up the parallel data lines. The delays are adjustable on a per data channel basis, and as such, the de-skew circuitry provides de-skewed data 7004. The de-skewed data is provided to a data processor 6003. The data processor processes the data and provides the data to other units (not shown). The de-skewed data is also provided to a sample unit 6005. The sample unit also receives a sample channel 7006. The sample channel, in one embodiment, carries data corresponding to a selected parallel data line, with the selection of the parallel data line varying over time. The sample unit compares data on the sample channel with a corresponding de-skewed data channel. Based on the results of the comparison, the sample unit provides an adjustment signal 7008 to the de-skew circuitry. The adjustment signal informs the de-skew circuitry of the appropriate delay for a particular data channel.

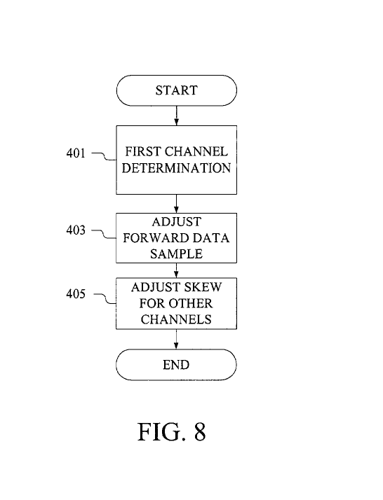

A flow diagram of a process implemented by the processing unit to de-skew the data channels is illustrated in FIG. 8. In Block 401 the process sets a sampling point for the first data channel. In Block 403 the process selects the forward data sample from the first data channel, and sets a delay for the sample channel such that the sample data in the forward sample data matches that of the first data channel. In Block 405 the process selects a sample point for each of the remaining channels such that data in each of the channels matches corresponding delayed sample data from the sample channel for each of the channels. Thus, all of the data channels are set to sampling points such that all of the data channels are aligned to the first data channel.

In alternative embodiments the delay, for the sample channel, is centered, and then the skew for each of the data channels is adjusted to match the delay of the sample channel. This has an advantage of not using different processing for different data channels, or for the first data channel, for skew adjustment.

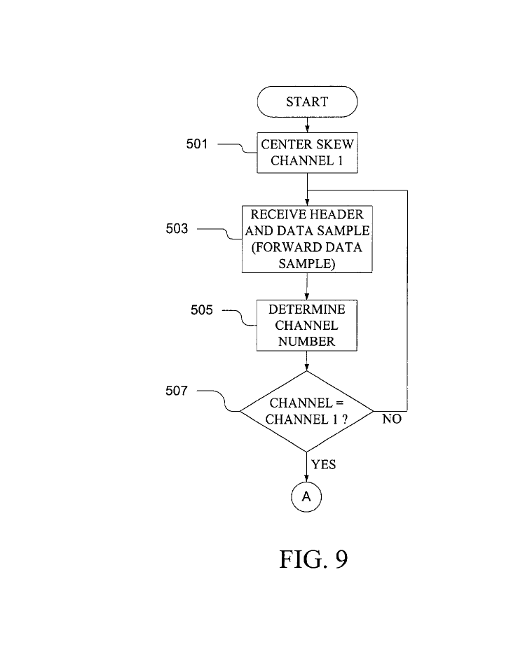

FIG. 9 illustrates a flow diagram of one embodiment of a subprocess for setting a sampling point of a first data channel for skew adjustment. In Block 501 the process sets a de-skew circuit to sample the first data channel at the midpoint of the de-skew range of the de-skew circuit. In one embodiment the actual sampling point is not necessarily at the exact midpoint of the de-skew range, but is adjusted so as to sample the first data channel approximate a center of a data eye near the midpoint of the de-skew range.

In Block 503 the process receives a forward data sample. In Block 505 the process determines the channel number specified by the forward data sample. If the process in Block 507 determines that the channel number does not correspond to the first data channel the process returns to Block 503, otherwise the process returns.

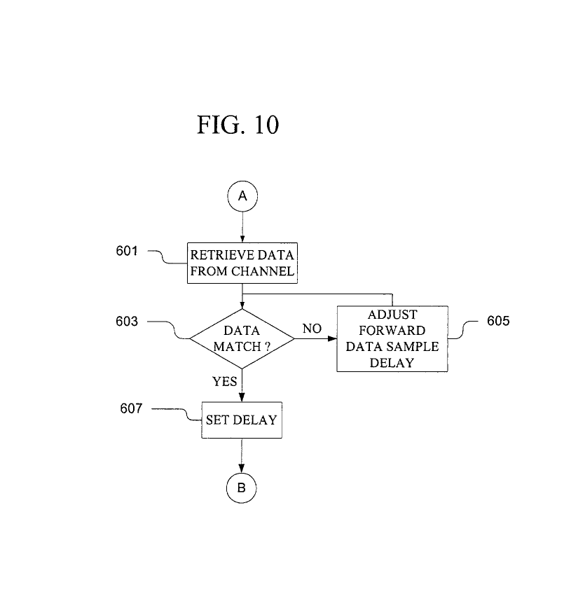

Upon return the process continues to Block 403 and adjusts the forward data sample delay. A flow diagram of one embodiment of a subprocess for adjusting a forward data sample delay is illustrated in FIG. 10. In Block 601, the process retrieves data from the first data channel. In Block 603 the process compares the data from the first data channel with a slice of delayed data from the sample channel. If data does not match, the process selects another slice of delayed data from the sample channel in Block 605, and returns to Block 603. If the data matches the process sets the delay of the sample channel to match the slice in Block 607 and returns.

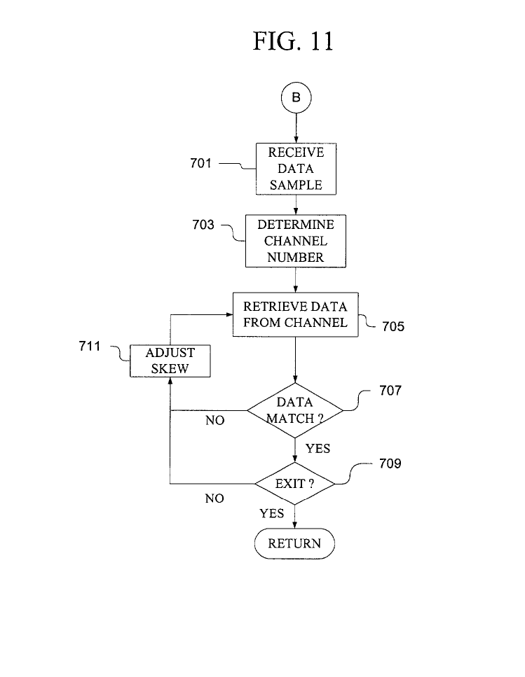

Once the delay of the sample channel is set the process returns to Block 405 of the process of FIG. 8 and adjusts the skew for the remaining data channels. FIG. 11 illustrates a flow diagram of one embodiment of a subprocess for adjusting the skew for the remaining data channels. In Block 701 the process receives a forward data sample. In Block 703 the process determines the channel number identified in the forward data sample. In Block 705 the process retrieves data from the data channel corresponding to the channel number. In Block 707 the process compares the retrieved data with delayed data from the forward data sample. If the data does not match then the process adjusts the sampling point of the data channel in block 711. In one embodiment the process receives a string of data from the data channel significantly greater in length than the data contained in the data sample, and compares slices of the string of data to determine the appropriate sample point to match the sample data.

In one embodiment, and as illustrated in FIG. 11, the data channel is not thereafter examined until a further forward data sample for that data channel is received. If the data matches the skew of the data channel appropriately, and the process determines that all channels have been appropriately adjusted in Block 709, the process returns. Otherwise the process continues adjusting the sampling point for additional data channels in block 711.

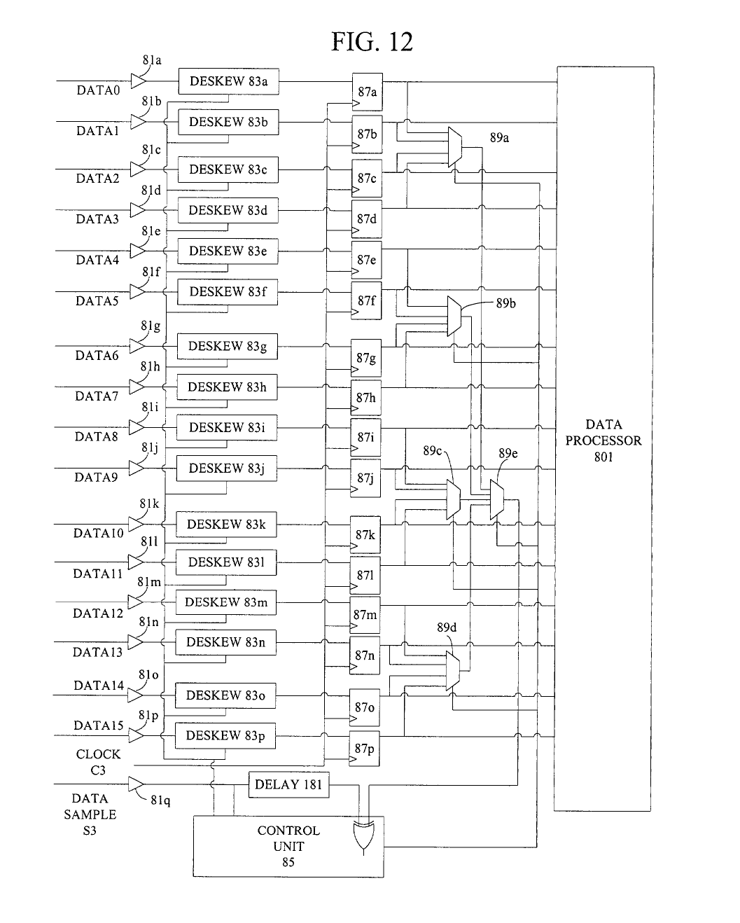

FIG. 12 illustrates a semi-schematic diagram of one embodiment of a downstream unit. As illustrated thedownstream unit is a processing unitwhich receives 16 data channels DATA0-DATA15. The processing unit also receives a sample channel S3. Each of the channels is provided to a buffer 81a-q. The buffers receiving data channel signals provide the signals to de-skew units 83a-p. In one embodiment, the de-skew units provide both coarse and fine adjustment, and the de-skew units are, each individually, under the control of de-skew control unit 85. In another embodiment, fine control of the de-skew units is provided within the de-skew units to allow the de-skew units to select sampling points approximate the center of a data eye while the de-skew control determines coarse control as to which bits begin a sequence of data. In other words, in such an embodiment the de-skew unit provides bit alignment, while the de-skew control determines byte, word, or other alignment. Thus, in alternative embodiments the de-skew unit includes a clock and data recovery unit, with one embodiment performing the clock and data recovery function by comparing results at different sample points within the data eye with results from the sample channel.

The output of each de-skew unit is provided to a corresponding latch of latches 87a-p. The latches are clocked by a clock signal C3. The outputs of the latches are provided to a processor and to one of several multiplexers. The processor 801 performs, for example, descrambling and SONET framing.

As illustrated, the processing unit also includes five 4×1 multiplexers 89a-e. Data samples DATA0-DATA3 are provided to a first multiplexer 89a, data samples DATA4-DATA7 are provided to a second multiplexer 89b, data samples DATA8-DATA11 are provided to a third multiplexer 89c, and data samples DATA12-DATA15 are provided to a fourth multiplexer 89d. The output of each of the first, second, third, and fourth multiplexers are in turn provided to a fifth multiplexer 89e, whose output is provided to the de-skew control unit. The de-skew control unit controls the selector of the multiplexers so as to be able to select data from a particular data channel.

A delay element 181 is also under the control of the de-skew control unit. In one embodiment the delay element is a tapped buffer, with the taps allowing selection of a delay period of the delay element. The output of the delay element is provided to the de-skew control, which allows the de-skew control to compare data from the delay element with data from the data channels.

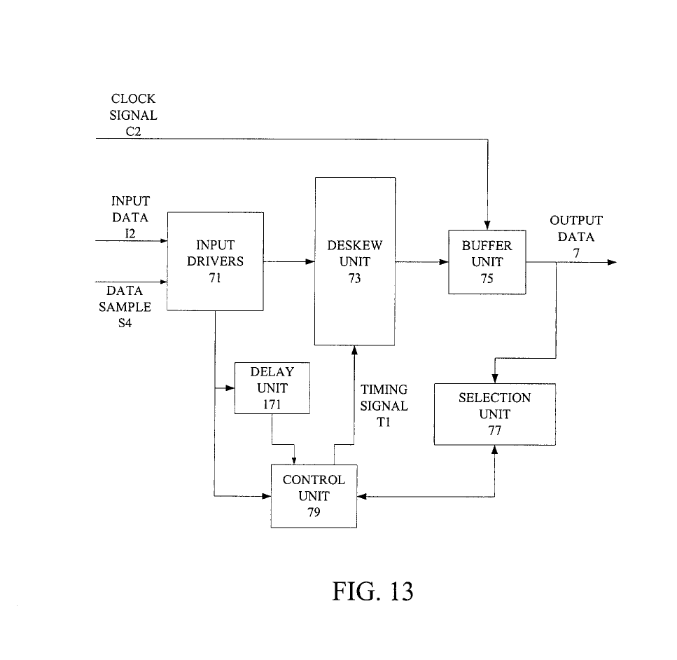

FIG. 13 illustrates a further block diagram of one embodiment of a processing unit. In FIG. 13, input drivers 71 receive input data I2 and a data sample S4. The input data and data sample, in one embodiment, is information provided from a SERDES (not shown). The input data is in parallel form and, in one embodiment, includes sixteen data channels. The data sample is an aggregation of portions of data. The input drivers supplies the parallel data to a deskew unit 73 and the data sample to a control unit 79. The data sample is also supplied to a delay unit 171. The delay unit is a configurable unit which is able to adjust the timing of the data sample. In one embodiment, the control unit configures the timing delay of the delay unit. The delayed sample data from the delay unit is supplied to the control unit.

The deskew unit supplies the data, in parallel form, to a buffer unit 75. A clock signal C2 is also supplied to the buffer unit 75. Based on the clock signal, the buffer unit transmits the data to, in one embodiment, another processing unit (not shown).

The buffer unit also forwards data to a selection unit 77. The control unit is coupled to the selection unit and commands the selection unit to generate or select specific samples or portions of data received from the buffer unit. In one embodiment, the data selection is performed in a round-robin fashion. The control unit aggregates the samples of data to form a second data sample signal. The control unit compares the second data sample signal to the delayed data sample and/or the data sample signal from the input drivers. Based on the comparison of the signals, the control unit determines a timing signal T1. The timing signal is supplied to the deskew unit to adjust the timing of the data supplied to the buffer unit. In one embodiment, the deskew unit delays some or all of the parallel data to the buffer by a specific delay as indicated by the timing signal.

Thus, for example, the SERDES of FIG. 5 and the processing unit of FIG. 12 are able to de-skew parallel data channels, and to do so without the use of training patterns or the like being transmitted in the data channel, although in some embodiments it is convenient to use such patterns to further data channel de-skew. In one embodiment, for example, pre-emphasis adjustment to the outgoing waveform is adjusted by for example a SERDES, i.e., an upstream unit, to increase the ability of the processing unit to read transmitted data. In a further embodiment a control signal from the processing unit to the SERDES provides information to the SERDES for use in waveform shaping. In some embodiments the information provides information regarding the nature or characteristics of the processing unit, and in other embodiments the information provides commands as to waveform adjustment. In addition, in further embodiments the system continues operation once de-skew is complete in order to monitor alignment of the data in the data channels, and to recommence de-skew operations when data is out of alignment. Further, in various embodiments the sample channel is also used to provide information on the status of the interface or other out of channel information.

The processing unit is generally the downstream unit, although in alternative embodiments, the SERDES and the processing unit are bidirectional. Thus, each may be either or both the downstream unit and the upstream unit, as would be understood by those of ordinary skill in the art.

FIG. 14 illustrates portions of a deskew function. Each of 16 parallel data lines are provided to buffers 1507. The buffers may take the form, for example of FIFOs, including tapped FIFOs. Each of the FIFOs receive potentially varying control or clocking signals, allowing for alignment and synchronization of the parallel data lines.

Referring somewhat more specifically to the embodiment of FIG. 14, in FIG. 14 an external reference clock 1501 is supplied to a phase-locked loop (PLL) or digital locked loop (DLL) 1505. The PLL or DLL is coupled to a clock phase generator 1503. The phase-locked loop circuit ensures that the clock signal supplied to the clock phase generator does not vary, e.g., remains in phase, from the external reference clock. In one embodiment, the external reference clock 1501 is supplied directly to a clock phase generator 1503.

The clock phase generator slices the reference clock. In the embodiment described, the phase generator creates a number of clock signals, each of the same frequency, but phase-shifted with respect to each other. Thus, in one embodiment the clock phase generator creates the external reference clock into sixteen clock signals, each phase shifted 22.50 degrees from another clock signal.

The clock phase generator supplies an output signal to each FIFO unit 1507a-1507q. Each output signal is based on the sixteen clock signals. In one embodiment the output signal is merely one of the sixteen clock signals. In another embodiment the output signal is a weighted sum of the sixteen clock signals, in one instance as is described in U.S. patent application Ser. No. 09/265,725, the disclosure of which is hereby incorporated by reference. A phase select per channel signal 1509 selects, or determines, the clock signal, or weights of clock signals, for the output signal supplied to each FIFO unit for each channel. In other words, the phase select per channel signal 1509 is supplied to the clock phase generator to select the output from the clock phase generator, e.g., a clock signal from the clock phase generator. The phase select per channel signal is provided by a de-skew controller (not shown in FIG. 14).

The FIFO units also receive a clock signal 1511 and a respective data channel DATA0-DATA15, as inputs. In one embodiment the clock signal has a substantially higher rate than the data rate for the data channels. Information, digital data, on each data channel is clocked into the corresponding FIFO unit by the clock signal. Information on each data channel is then clocked out by the output from the clock phase generator as selected by the phase select per channel signal.

Thus, this allows digital data for each channel to be delayed in a FIFO unit or register for that channel, and released from the register at a time that is a controlled fraction of a clock period. The clock period, which is externally controlled, is not subject to variations due to manufacturing process or environmental variables. Therefore, the de-skew time, the time differences between channels, is referenced to the externally controlled clock. In many instances, it would be desirable for the de-skew time to remain constant. However, there may be cases where unavoidable delays in the data transmission path vary in a known way with environmental variables such as temperature. In this case, the fraction of the clock period used to de-skew the channel could be adjusted to compensate the known dependency in the unavoidable delay. As such, the need for clock recovery on the downstream side of the interface could be reduced.

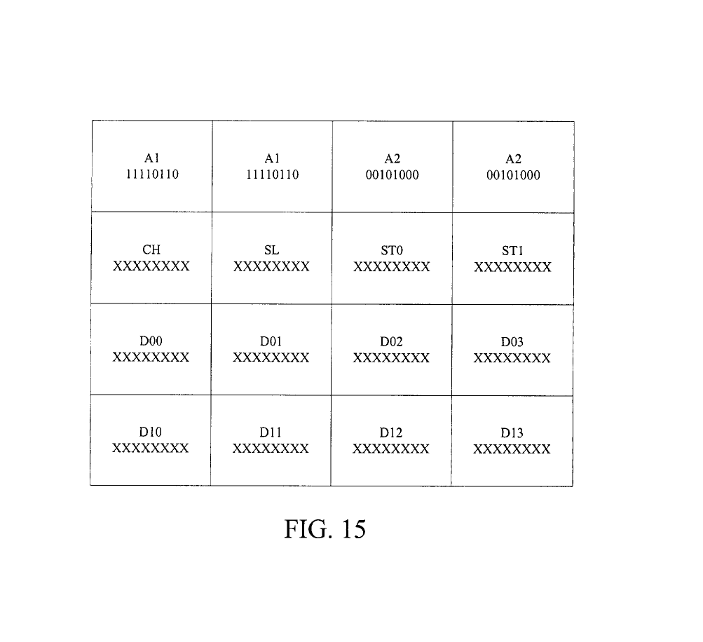

In one embodiment, as illustrated in FIG. 15, the data sample frame includes a header containing a fixed pattern, the replicated channel number, the sample length and a status word. The remainder of the frame includes a fixed quantity of data sample from the selected data channel. In one embodiment, where interfaces use asymmetric de-skew hardware replacement, the header is not utilized. As such, one extra signal, the clock signal, is supplied to indicate the start of the data sample switching to the first channel. The period of the clock would be the number of channels times the sample size.

Referring again to FIG. 15, the header includes a thirty-two bit frame delimiter containing the pattern of A1A1A2A2. Following the delimiter, eight bits are provided to indicate the channel number CH, i.e., the channel from which the sample data will be taken. The sample length SL is indicated by an eight bit word. In one embodiment, the length of a sample is indicated in thirty-two bit words. Finally, a sixteen-bit status word ST0 and ST1 is provided to indicate, for example, errors. Accordingly, the total header size is sixty-four bits in the illustrated embodiment. A sixty-four bit data sample D00-D03 and D10-D13 follows the header.

For a skew tolerance of eight bit times, the de-skew time was approximately 128 bit times plus 128 bit times per channel. As such, a sixteen bit bus would require approximately 2200 bit times to de-skew. At a typical protocol rate that is approximately 900 nano seconds. Larger skews based on different applications of the system may require linearly increasing amounts of time to de-skew. In order to allow for arbitrary data, the pattern length should exceed the required skew tolerance. For example, a repeating 1010 pattern would allow unique realignment of less than two bits of skew.

For a skew tolerance of eight bit times, the de-skew hardware would require approximately two thousand logic gates for the de-skew controller plus one hundred gates per channel. As such, a sixteen bit data bus would approximately require 3,600 gates to de-skew. Furthermore depending upon the limitation, greater skews may require a greater amount of linearly increasing hardware to de-skew. However, increasing de-skew time could be traded partially for hardware. For interfaces using asymmetric de-skew hardware replacement, the header generation and samples selection hardware would approximately require four hundred gates. For one extra signal, the header could also be eliminated. As such, the selection hardware would be reduced to approximately forty gates.

Thus, the present invention provides forward data de-skew methods and systems. Although described in certain specific embodiments, it should be understood that the present inventions may be practiced otherwise than as specifically described, the bounds of the present invention being set by claims and their equivalents supported by the description herein.

1. A de-skew system comprising:
a plurality of data channels over which data is transmitted;
a plurality of selectors coupled to the plurality of data channels; and
a controller coupled to the plurality of selectors and configured to cause the selectors to provide data from a desired data channel for transmission over a forward data sample channel.

2. The system of claim 1 wherein data transmitted over the forward data sample channel comprises a forward data sample, the forward data sample further including a header.

3. The system of claim 2 wherein the header comprises a fixed pattern and at least one channel number.

4. The system of claim 2 wherein the header further comprises sample length and status words.

5. The system of claim 2 wherein the header precedes the forward data sample.

6. The system of claim 1 further comprising:
a processor receiving data from the plurality of data channels and the forward data sample channel; and
a de-skew module configured to collect portions of the received data and to adjust collection of each of the received data based on the received forward data sample and the collected portions of the received data.

7. A de-skew system comprising:
a processor configured to receive input data and generate parallel data;
a buffer unit receiving the generated parallel data and a clock signal and generating a plurality of data signals based on the received generated data and clock signal; and
a control unit configured to collect portions of the plurality of data signals and to generate a forward data sample based on the collected portions of the plurality of data signals.

8. The system of claim 7 further comprising:
de-skew units each receiving at least one of the plurality of data signals and adjusting received data based on a timing signal; and
a control unit configured to collect portions of the plurality of data signals and to generate the timing signal based on the forward data sample and the collected portions of the plurality of data signals.

9. The system of claim 8 further comprising input drivers receiving the plurality of data signals and the forward data sample and supplying the plurality of data signals to the de-skew units and the forward data sample to the control unit.

10. The system of claim 9 further comprising a buffer unit receiving data from the de-skew units and a clock signal and generating a plurality of data signals based on the received clock signal.

11. The de-skew system of claim 7 further comprising:
a delay unit receiving the forward data sample and generating a delayed forward data sample delayed by a predetermined amount of time; and
wherein the control unit receives the delayed forward data sample and generates the timing signal based on the delayed forward data sample and the collected portions of the plurality of data signals.

12. A de-skew method comprising:
receiving data from a plurality of data channels;
selecting a portion of data from each of the received data from the plurality of data channels; and
generating a forward data sample comprising the selected portions of data.

13. The de-skew method of claim 12 further comprising
receiving the forward data sample;
identifying the portion of data corresponding to the received data from the plurality of data channels;
determining a delay based on timing between the portion of data and the corresponding received data; and
passing the received data along the plurality of data channels after the determined delay.

14. A de-skew method comprising:
centering a forward data sample;
comparing the forward data sample to data on one of the plurality of data channels; and
determining a time variation between the data and the forward data sample when the forward data sample corresponds to the data.

15. The method of claim 14 further comprising delaying the forward data sample based on the determined time variation.

16. The method of claim 14 wherein centering the forward data sample further comprises:
setting a sampling point of a first data channel; and
sampling the first data channel at the set sampling point.

17. The method of claim 14 wherein centering the forward data sample further comprises sampling the first data channel at a midpoint of a predetermined de-skew range.

18. The method of claim 14 wherein centering the forward data sample further comprises sampling the first data channel at approximate a center of a data eye of the first data channel and near a midpoint of a predetermined de-skew range.

19. A de-skew method comprising:
determining a channel number for a forward data sample;
retrieving data from a data channel identified by the channel number, the data channel being a first data channel;
comparing the data from the first data channel with a slice of delayed data from the forward data sample; and
adjusting timing of the forward data sample when the data from the first data channel corresponds to the slice of the delayed data.

20. The method of claim 19 wherein adjusting time of the forward data sample comprises delaying the forward data sample by an amount of time the slice of delayed data is delayed.

21. A de-skew method comprising:
selecting data from specific channel of a plurality of channels;
centering skew adjustment for the specific channel;
adjusting a forward data sample until data in the forward data sample matches the selected data;
selecting another channel of the plurality of channels;
adjusting skew on the selected channel until data in the selected channel matches the forward data sample; and
rotating through all the plurality of channels to select and adjust skew of all the plurality of channels to match the forward data sample.

22. The method of claim 21 further comprising:
receiving a header; and
decoding the header to determine a channel number.

23. The method of claim 22 wherein the header comprises a fixed pattern and at least one channel number.

24. The method of claim 22 wherein the header further comprises sample length and status words.

25. The method of claim 22 wherein the header precedes the forward data sample.

26. The method of claim 25 where the forward data sample comprises a fixed quantity of data samples.

27. The method of claim 21 further comprising word aligning data from the plurality of channels.

28. The method of claim 21 further comprising byte aligning data from the plurality of channels.

29. The method of claim 21 wherein centering skew adjustment further comprises centering a sampling point of the selected channel.

30. The method of claim 21 wherein center skew adjustment further comprises:
sampling a plurality of points of data from the selected data channel; and
comparing the plurality of sampled points to determine a center of the data of the selected data channel.

31. A method of deskewing parallel data channels between a transmitting unit and a receiving unit using a forward sample channel, the transmitting unit providing data signals to the receiving unit over the parallel data channels and also providing sample signals to the receiving unit over the forward sample channel, the method comprising:
selecting a data channel for deskewing;
transmitting data over the data channel;
transmitting the data over the forward sample channel;
comparing received data transmitted over the data channel with received data transmitted over the forward sample channel; and
deskewing the data channel based on the comparison.

32. The method of claim 31 further comprising selecting a further data channel for deskewing;
transmitting further data over the further data channel;
transmitting the further data over the forward sample channel;
comparing received further data transmitted over the further data channel with received further data transmitted over the forward sample channel; and
deskewing the further data channel based on the comparison.

33. The method of claim 32 further comprising transmitting a header over the forward data sample.

34. The method of claim 33 wherein the header includes an indication of the selected channel.

35. The method of claim 34 wherein the header is transmitted over the forward sample channel prior to transmission of data for a data channel over the forward sample channel.

36. The method of claim 35 where deskewing is accomplished by adjusting a delay in the path of data received over the data channels in the receiving unit.

37. A method of deskewing parallel data lines comprising:
providing parallel data over a plurality of parallel data lines, the parallel data lines providing parallel data from a first unit to a second unit;
successively providing sample data over a sample channel, the sample data corresponding to data of the parallel data, the sample channel providing sample data from the first unit to the second unit; and
using the sample data to align the parallel data.

38. A system including deskew functions comprising:
an upstream unit providing parallel data to a downstream unit over parallel data channels;
a downstream unit receiving the parallel data from the upstream unit over the parallel data channels;
a sample channel coupling the upstream unit and the downstream unit, the sample channel carrying samples of the parallel data from the upstream unit to the downstream unit.

39. The system including deskew functions of claim 38 wherein the upstream unit includes a sampler for placing samples of data from a selected parallel data line on the sample channel.

40. The system including deskew functions of claim 39 wherein the downstream unit includes a deskew circuitry for each of the parallel data channels.

41. The system including deskew functions of claim 40 wherein the downstream unit includes control circuitry providing adjustments to the deskew circuitry based on a comparison of portions of the parallel data and data provided over the sample channel.
